(19) United States
(12) Patent Application Publication
(10) Pub. No.: US 2004/0162662 A1
(43) Pub. Date: Aug. 19, 2004

(54) Method for controlling driving stability

(76) Inventors: Volker Bremeier, Frankfurt am Main (DE); Thorsten Wickenhofer, Frankfurt am Main (DE)

Correspondence Address: Gerlinde M Nattler, Continental Teves Inc, One Continental Drive, Auburn Hills, MI, 48326, US

(21) Appl. No.: 10/480,556

(22) PCT Filed: Jun. 10, 2002
(86) PCT No.: PCT/EP02/06344

(30) Foreign Application Priority Data
Jun. 13, 2001 (DE) 101 28 690.2

(51) Int. Cl. G06F 19/00

(52) U.S. Cl. 701/70

(57) ABSTRACT

The present invention relates to a method for controlling driving stability wherein pressures for the individual brakes are determined by means of several input variables so that driving stability of the vehicle is enhanced as a result of ESP intervention. To provide a modification of the ESP driving stability control which actively prevents understeering, it is determined in a cornering maneuver with an understeering driving behavior whether force is transmitted between vehicle tire and roadway in a correlation to a limit value Gₛₗᵢₚ during ESP intervention at the curve-inward rear wheel, with ESP intervention being executed at the curve-inward front wheel in addition to the curve-inward rear wheel when the limit value is reached or exceeded.

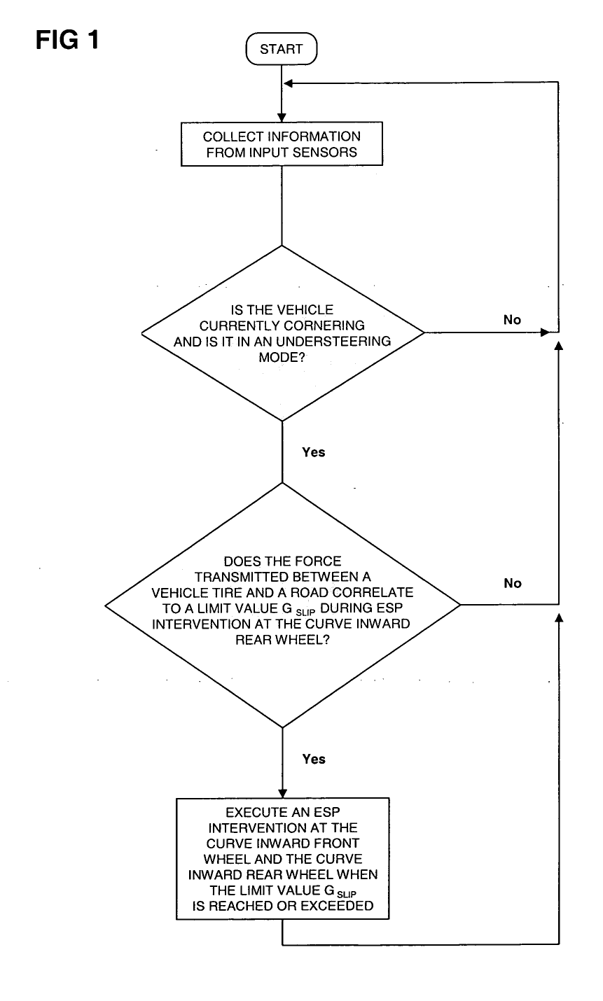

The present invention relates to a method for controlling driving stability wherein pressures for the individual brakes are determined by means of several input variables so that driving stability of the vehicle is enhanced as a result of ESP intervention.

A large number of driving stability control systems have become known in the art that are used to automatically counteract vehicle instabilities. The term ‘driving stability control’ combines four principles of influencing the driving performance of a vehicle by means of predeterminable pressures or brake forces in or at individual wheel brakes and by means of intervention into the engine management of the driving engine. These principles are brake slip control (ABS) intended to prevent individual wheels from locking during a braking operation, traction slip control (TSC) preventing the driven wheels from spinning, electronic brake force distribution (EBV) controlling the ratio of brake forces between front and rear axle of the vehicle as well as yaw torque control (ESP) ensuring stable driving conditions when the vehicle yaws about its vertical axis.

Hence, the term ‘vehicle’ in this context implies a motor vehicle with four wheels, which is equipped with a hydraulic, electrohydraulic or electromechanical brake system. The driver is able to develop brake pressure in the hydraulic brake system by means of a pedal-operated master cylinder, while the electrohydraulic and electromechanical brake systems develop a brake force responsive to the sensed braking request of the driver. A hydraulic brake system will be referred to in the following. Each wheel has a brake associated with which is an inlet valve and an outlet valve, respectively. The wheel brakes are in connection to the master cylinder by way of the inlet valves, while the outlet valves lead to a non-pressurized reservoir or low-pressure accumulator. Also, there is provision of an auxiliary pressure source able to build up pressure in the wheel brakes even independently of the position of the brake pedal. The inlet and outlet valves are electromagnetically operable for pressure control in the wheel brakes.

To sense driving-dynamics conditions, there are four rotational speed sensors, one per wheel, i.e. one yaw velocity sensor, one transverse acceleration sensor and at least one pressure sensor for the brake pressure generated by the brake pedal. Instead of the pressure sensor, a pedal-travel or pedal-force sensor may also be used if the auxiliary pressure source is so arranged that brake pressure built up by the driver cannot be distinguished from the brake pressure of the auxiliary pressure source.

The driving performance of a vehicle is influenced in a driving stability control operation so that it is easier to master for the driver in critical situations. A critical situation in this respect is an unstable driving condition when the vehicle will not follow the specifications of the driver in the extreme case. Thus, the function of driving stability control in such situations is to impart to the vehicle the vehicle performance the driver requests, within physical limits. Unstable driving performance of a vehicle can be caused by understeering, when the measured yaw rate differs from the yaw rate to be achieved in such a way that the vehicle will not turn into the curve to the extent expected.

ESP understeering intervention with decelerating of the curve-inward rear wheel that will occur in this case has no effect in particular in steady-state cornering maneuvers with a major understeering tendency and a high transverse acceleration level with vehicles having a significant rolling tendency or using certain rear-axle constructions (e.g. twist-beam rear axle) because the curve-inward rear wheel will lift in these driving situations. In addition, ESP understeering intervention has only a limited effect due to the normal force reduction of the curve-inward vehicle side in especially heavy vehicles. Understeering driving situations of this type come up when the driver in conditions with a high coefficient of friction predetermines or must predetermine a steering angle on account of the course of the curve, which the vehicle is unable to follow at the current speed. Thus, the actual reason for the understeering instability detected by ESP control in such situations must be seen in a vehicle speed that is not adapted to the course of the curve and the high transverse acceleration level that is due to the mentioned speed. ESP understeering intervention at the curve-inward rear wheel does not allow reducing driving instability, or allows it only to a limited extent, by introducing a yaw torque about the vertical vehicle axis. Reduction of the understeering tendency is only achieved when a braking effect of the understeering intervention can be reached or increased.

ESP understeering intervention is significant even for vehicles with a high point of gravity of the body (e.g. off-road vehicles). Due to the high transverse accelerations encountered under the mentioned marginal condition, the normal force of the curve-inward wheels in these vehicles is so greatly reduced that the brake forces that can be built up likewise do not even allow stabilizing development of a yaw torque. As the vehicle speed is reduced to a small degree only, instability of these vehicles will also rise due to the non-restricted transverse acceleration level. In addition, reduction of the normal force level that further diminishes the effect of ESP understeering intervention can be brought about also by a shift of the vehicle's point of gravity in the direction of the front axle (e.g. vehicles with front-wheel drive in addition to a low overall mass).

An object of the present invention is to provide a modification of the ESP driving stability control that actively prevents understeering.

According to the present invention, this object is achieved in that a generic method is so executed that it is determined in a cornering maneuver with an understeering driving performance whether force is transmitted between vehicle tire and roadway in a correlation to a limit value Gₛₗᵢₚ during ESP intervention at the curve-inward rear wheel, with the ESP intervention being executed at the curve-inward front wheel in addition to the curve-inward rear wheel when the limit value is reached or exceeded.

As this occurs, ESP understeering intervention is modified in such a way that apart from decelerating the curve-inward rear wheel, an appropriate amount of brake pressure is additionally introduced into the curve-inward front wheel in the ABS control range. The lateral force is reduced with the longitudinal force introduced in this fashion by way of the brake pressure, with the tire deforming in the direction of the resulting total force, that is both in longitudinal and transverse directions. The distribution of the total force, which can be transmitted by a wheel within limits only, may be represented in approximation by Kamm's friction circle. The loss in cornering force will diminish the torque that counteracts understeering, where the measured yaw velocity differs in such respect from the desired yaw velocity that the vehicle will not turn into the curve to the extent expected. Thus, the loss in cornering force counteracts the development of yaw torque counteracting understeering of the vehicle. The torque about the vertical axis of the vehicle that is induced by the reduction of the lateral force will rise with increasing longitudinal slip. A longitudinal force that can maximally be transmitted between tire and roadway will occur at roughly 15% longitudinal slip corresponding to the μ-slip curve, this corresponds to the control range of ABS. With this longitudinal slip the loss in lateral force is still relatively low. Therefore, the method of the invention will produce at the curve-inward front wheel, as a sum of longitudinal and lateral forces, a torque about the vertical axis in opposition to the understeering curve path of the vehicle. The method permits vehicle stabilization in the case of understeering, or improving stabilization, in particular for vehicles with a twist-beam rear axle (rigid axle), but also in vehicles with high weight, where a sole braking intervention at the curve-inward rear wheel is not sufficient. The special ESP intervention allows actively preventing understeering especially for these vehicles.

It is favorable according to an embodiment that the ESP intervention at the curve-inward front wheel takes place when the limit value Gₛₗᵢₚ has reached or exceeded a slip value λ≧0% to 20%.

Advantageously, ESP intervention at the curve-inward front wheel takes place when the limit value Gₛₗᵢₚ has reached or exceeded a slip value λ between 10% and 20% because the build-up of longitudinal force at the curve-inward rear wheel is exhausted in this case during dynamic understeering intervention. ESP understeering intervention that takes place in this case with decelerating of only the curve-inward rear wheel has no effect in cornering maneuvers with a major understeering tendency and a high transverse acceleration level with vehicles having a significant rolling tendency or with certain rear-axle constructions (e.g. twist-beam rear axle) because the curve-inward rear wheel will lift in these driving situations.

In addition, ESP understeering intervention has only limited effect due to the normal force reduction of the curve-inward vehicle side in vehicles with a high total weight. Therefore, ESP intervention at the curve-inward front wheel may also be executed in that the limit value Gₛₗᵢₚ is set to a slip value λ of 0% so that brake pressure is introduced into the two curve-inward wheels with each ESP understeering intervention. Favorably, a higher total torque about the vehicle vertical axis at an increased reduction of the longitudinal speed is hereby achieved.

The transverse acceleration of the vehicle is so monitored that in ESP intervention at the curve-inward rear wheel and/or front wheel the transverse acceleration at the front wheels is detected and compared with a limit value G_{transverse/top/bottom}. The deviation of the transverse acceleration from the limit value G_{transverse/top/bottom} during the ESP intervention is determined, and the dynamics of the driving maneuver is evaluated in a correlation with the slip value. Thus, low friction values between tires and roadway may be concluded from high slip values and a low transverse acceleration.

It is expedient that a top limit value G_{transverse/top} is fixed for each individual wheel, which upon control of the curve-inward front wheel is considered when the transverse acceleration reaches or falls below a bottom limit value G_{transverse/bottom}.** The limit value G_{transverse/bottom} may range between 1 m/s² and 3 m/s², it preferably amounts to 2 m/s².

Favorably, the limit value (Gₜᵣₐₙₛᵥₑᵣₛₑ\hat{=}λ=0) can also be set to zero when the objective is to constantly introduce brake pressure into the curve-inward wheels, that is the front wheel and the rear wheel, in ESP understeering intervention.

It is advantageous that ESP intervention at the curve-inward front wheel takes place when the following conditions are satisfied:

1. The model-based maximum lateral force for the essentially linear range on the front axle is exceeded.

2. ESP engine torque reduction is not activated.

3. The measured steering angle α_{Meas} is smaller than a model-based steering angle α_{mod el}, where the direction of rotation of the torque introduced by the brake pressures (longitudinal force) changes.

The steering angle α_{mod el} of the condition α_{Meas}<α_{mod el} mentioned under item 3 can be determined according to the relation

$${α}_{model} = arctan ( \frac{s}{{l}_{f} * 2} )$$

where l_{f}=distance between the front axle and the point of gravity, s=track. Preferably, the condition is not based on the point of gravity of the vehicle but on half the vehicle's wheel base. Thus, it is taken into consideration that the point of gravity shifts in the direction of the rear axle with increasing vehicle loading.

Therefore, α_{Meas} is preferably determined according to the relation

$${α}_{model} = arctan ( \frac{s}{{l}_{f} + {l}_{r}} ) ,$$

where s=track, l=distance of the axle from the point of gravity and the indices f for the front axle and r for the rear axle.

Once these conditions are satisfied, brake pressure is introduced into the wheel brake at the curve-inward front wheel in addition to the curve-inward rear wheel.

It is especially favorable that in ESP intervention the brake pressure at the curve-inward front wheel is limited to a slip value that corresponds to the ABS wheel-lock pressure level. The feature that pressure build-up at the curve-inward front wheel is enabled up to the ABS control range, on the one hand, permits achieving a relatively great build-up of longitudinal force and, thus, a resultant maximum total force at a low reduction of lateral force, the total force bringing about a yaw torque about the vertical axis of the vehicle. On the other hand, controlling the brake pressure by means of ABS control prevents that the ABS controlled wheel becomes unstable in safety-critical spurious control operations. This is in particular significant with respect to the nowadays conventional provision of two brake circuits, with intervention occurring in both brake circuits according to the method of the invention.

Embodiment

1.1 Conditions of Entry into the Control and Termination Thereof

The entry into the control takes place, that means, a torque (yaw torque) about the vertical axis of the vehicle is produced by way of brake pressure development at the two curve-inward wheel brakes, when the following conditions are satisfied in ESP understeering intervention at the curve-inward rear wheel:

a. The ESP slip controller determines on the rear wheel a slip that is preferably higher than a limit value Gₛₗᵢₚ>15%

b. The transverse acceleration at the front axle exceeds a vehicle-individual limit value G_{transverse,top}

c. The model-based maximum lateral force for the substantially linear range at the front axle is exceeded in the single-track model (single-track model is greater than 1 in the model state), or

d. ESP engine torque reduction is not active

e. Braking by the driver is preferably not determined

f. The current steering angle α_{Meas} is smaller than the model-based steering angle α_{model} according to the relation

$${α}_{model} = arctan ( \frac{s}{{l}_{f} * 2} )$$

or the relation

$${α}_{model} = arctan ( \frac{s}{{l}_{f} + {l}_{r}} )$$

The ESP understeering intervention at both curve-inward wheels is prevented when

g. the ESP controller executes an oversteering intervention or

h. the actual yaw rate of the vehicle reaches the calculated nominal yaw rate,

i. a value drops below the limit value G_{transverse, bottom}.

ESP intervention and the corresponding control is exemplarily described in DE 195 15 065 A1 which is incorporated by full reference herein.

1.2 Brake Pressure Distribution

The build-up of the wheel-individual brake pressure at the curve-inward front wheel is carried out until the ABS control range. Therefore, build-up of pressure (longitudinal slip) at the controlled front wheel is limited to the ABS thresholds, that means, the ESP slip controller will not become active at the curve-inward front wheel.

1. Method for controlling driving stability wherein pressures for the individual brakes are determined by means of several input variables so that driving stability of the vehicle is enhanced as a result of ESP intervention,
characterized in that it is determined in a cornering maneuver with an understeering driving performance whether force is transmitted between vehicle tire and roadway in a correlation to a limit value Gₛₗᵢₚ during ESP intervention at the curve-inward rear wheel, with ESP intervention being executed at the curve-inward front wheel in addition to the curve-inward rear wheel when the limit value is reached or exceeded.

2. Method as claimed in claim 1,
characterized in that ESP intervention at the curve-inward front wheel takes place when the limit value Gₛₗᵢₚ has reached or exceeded a slip value λ≧0% up to 20%.

3. Method as claimed in claim 1 or 2,
characterized in that ESP intervention at the curve-inward front wheel takes place when the limit value Gₛₗᵢₚ has reached or exceeded a slip value λ between 10% and 20%.

4. Method as claimed in any one of claims 1 to 3,
characterized in that in the ESP intervention at the curve-inward rear wheel and/or front wheel the transverse acceleration at the front wheels is detected and compared with a limit value G_{transverse/top/bottom}.

5. Method as claimed in claim 4,
characterized in that the deviation of the transverse acceleration from the limit value G_{transverse/top/bottom} is determined during the ESP intervention, and driving dynamics is evaluated in correlation with the slip value.

6. Method as claimed in claims 4 or 5,
characterized in that a top limit value G_{transverse,top} is provided for the entry into the control of the curve-inward front wheel and a bottom limit value G_{transverse,bottom} is provided for the exit from the control of the curve-inward front wheel.

7. Method as claimed in any one of claims 1 to 6,
characterized in that ESP intervention at the curve-inward front wheel takes place when the condition is satisfied that the model-based maximum lateral force on the front axle is exceeded.

8. Method as claimed in any one of claims 1 to 7,
characterized in that ESP intervention at the curve-inward front wheel takes place when the condition is satisfied that ESP engine torque reduction is not activated.

9. Method as claimed in any one of claims 1 to 8,
characterized in that ESP intervention at the curve-inward front wheel takes place when the measured steering angle α_{Meas} is smaller than a model-based steering angle α_{mod el}, where the direction of rotation of the torque introduced by the brake pressures (longitudinal force) changes.

10. Method as claimed in claim 9,
characterized in that the model-based steering angle α_{mod el} is determined according to the relation
$${α}_{model} = arctan ( \frac{s}{{l}_{f} * 2} )$$
where l_{f}=distance between the front axle and the point of gravity, s=track.

11. Method as claimed in claim 9,
characterized in that the model-based steering angle α_{mod el} is determined according to the relation
$${α}_{model} = arctan ( \frac{s}{{l}_{f} + {l}_{r}} ) ,$$
where l_{f}=distance between the front axle and the point of gravity, lᵣ=distance between the rear axle and the point of gravity, s=track.

12. Method as claimed in any one of claims 1 to 11,
characterized in that in ESP intervention the brake pressure at the curve-inward front wheel is limited to a slip value that corresponds to the ABS wheel-lock pressure level.
